(19) United States
(12) Patent Application Publication
(10) Pub. No.: US 2016/0041110 A1
(43) Pub. Date: Feb. 11, 2016

(54) X-RAY TRANSMISSION INSPECTION APPARATUS AND EXTRANEOUS SUBSTANCE DETECTING METHOD

(71) Applicant: HITACHI HIGH-TECHNOLOGIES CORPORATION, Tokyo (JP)

(72) Inventors: Yoshiki MATOBA, Tokyo (JP); Akihiro TAKEDA, Tokyo (JP); Kaifeng ZHANG, Yokohama-shi (JP)

(21) Appl. No.: 14/805,269

(22) Filed: Jul. 21, 2015

(30) Foreign Application Priority Data
Aug. 11, 2014 (JP) 2014-163349

(51) Int. Cl. G01N 23/083; G21K 1/10; H04N 5/353; G01T 7/08

(52) U.S. Cl. CPC G01N 23/083; G01T 7/08; G21K 1/10; H04N 5/353

(57) ABSTRACT

An X-ray transmission inspection apparatus is provided with: an X-ray source configured to irradiate a sample with an X-ray; a sample moving mechanism configured to continuously move the sample in a specific direction during irradiation with the X-ray from the X-ray source; a TDI sensor disposed at a side opposite to the X-ray source with the sample interposed therebetween and configured to detect the X-ray transmitted by the sample; and a polycapillary disposed between the X-ray source and the sample and configured to convert the X-ray radially emitted from the X-ray source into a parallel X-ray parallel to a thickness direction of the sample.

### CROSS-REFERENCE TO RELATED APPLICATION

This application claims priority from Japanese Patent Application No. 2014-163349, filed on Aug. 11, 2014, the entire subject matter of which is incorporated herein by reference.

### BACKGROUND

1. Technical Field

The present disclosure relates to an X-ray transmission inspection apparatus capable of detecting an extraneous metal substance in a sample and an extraneous substance detecting method using the X-ray transmission inspection apparatus.

2. Description of the Related Art

In general, X-ray transmission inspection which is performed using an X-ray transmission image acquired by irradiating a sample with X-rays is used to detect an extraneous metal substance in the sample, thickness irregularity, or the like. In an apparatus used for the X-ray transmission inspection, when a strip-shaped sample is inspected in an in-line manner, a product (sample) conveyed in one direction is interposed between an X-ray generator generating an X-ray and a line sensor detecting the X-ray, which are disposed to face each other.

For example, JP-A-2004-061479 discloses an X-ray extraneous substance detection apparatus provided with plural X-ray generators, plural X-ray detectors, and plural aperture devices or shielding plates which are installed so as not to irradiate one X-ray generator in a different area with the X-rays emitted from another X-ray generator. The X-ray extraneous substance detection apparatus is provided with a line sensor as the X-ray detector that detects X-rays in a state in which a product conveyed with one surface directed to one side is interposed between the X-ray generators and the line sensor when a strip-shaped sample is inspected in an in-line manner. In the X-ray transmission inspection apparatus according to the related art, the line sensor having sensitivity to X-rays is disposed to face the X-ray generators, and a moving speed of the sample is synchronized with an output of the line sensor to form a two-dimensional X-ray transmission image while moving the sample in one direction, whereby extraneous substance inspection or the like is performed using the X-ray transmission image.

Since the aforementioned line sensor may not have sufficient sensitivity, in recent years, imaging is performed through a time delay integration (TDI) operation using a two-dimensional CCD. That is, by synchronizing a speed of an image obtained by projecting the transmission image of the sample onto a CCD plane with a vertical transfer speed of the CCD, the sensitivity can be improved in a multiple of the number of vertical stages of the CCD, thereby achieving an increase in inspection speed. The TDI operation using a CCD has been more widely used in the field of the X-ray transmission inspection apparatus.

The above-described technique according to the related art may have the following problems.

In an extraneous substance detection apparatus using X-ray transmission according to the related art, when a sample as a detection object is relatively thin, there may occur no problem. However, when a sample has a thickness of several millimeters or more, the following problems may occur.

That is, as illustrated in FIG. 6, when extraneous substance A is present on the top side (X-ray source 2 side) in a relatively-thick sample S and extraneous substance B is present on the bottom side (TDI sensor 4 side) just below extraneous substance A, there is a problem in that, when the speed is synchronized with the speed of extraneous substance A, the speed is not synchronized with the speed of extraneous substance B and an X-ray transmission image which is vertically accumulated by a CCD (TDI sensor 4) blurs.

More specifically, X-rays are radially emitted from the X-ray source 2, the moving speed of extraneous substance A, which has a distance LA from the X-ray source 2, on the TDI sensor 4 is expressed by “Vs×L/LA” and the moving speed of extraneous substance B, which has a distance LA from the X-ray source 2, on the TDI sensor 4 is expressed by “Vs×L/LB”. That is, since the moving speeds of extraneous substances A and B on the TDI sensor 4 are different from each other, there is a problem in that when the speed is synchronized with the moving speed of one extraneous substance, the other extraneous substance blurs.

### SUMMARY

The present disclosure has been made in view of the above-described circumstances, and one of objects of the present disclosure is to provide an X-ray transmission inspection apparatus and an extraneous substance detecting method capable of improving sensitivity by detecting an extraneous substance without causing a blur in a transmission image due to speed asynchronization even in the case of a thick sample.

According to an exemplary embodiment of the present disclosure, there is provided an X-ray transmission inspection apparatus including: an X-ray source configured to irradiate a sample with an X-ray; a sample moving mechanism configured to continuously move the sample in a specific direction during irradiation with the X-ray from the X-ray source; a TDI sensor disposed at a side opposite to the X-ray source with the sample interposed therebetween and configured to detect the X-ray transmitted by the sample; and a polycapillary disposed between the X-ray source and the sample and configured to convert the X-ray radially emitted from the X-ray source into a parallel X-ray parallel to a thickness direction of the sample.

According to another exemplary embodiment of the present disclosure, there is provided an extraneous substance detecting method using an X-ray transmission inspection apparatus including an X-ray source configured to irradiate a sample with an X-ray, a sample moving mechanism configured to continuously move the sample in a specific direction during irradiation with the X-ray from the X-ray source, a TDI sensor disposed on a side opposite to the X-ray source with the sample interposed therebetween and configured to detect the X-ray transmitted by the sample, and a polycapillary disposed between the X-ray source and the sample. The method includes: causing the polycapillary to convert the X-ray radially emitted from the X-ray source into a parallel X-ray parallel to a thickness direction of the sample; and causing the sample moving mechanism to continuously move the sample in a specific direction during irradiation with the parallel X-ray.

### BRIEF DESCRIPTION OF THE DRAWINGS

The above and other aspects of the present disclosure will become more apparent and more readily appreciated from the following description of illustrative embodiments of the present disclosure taken in conjunction with the attached drawings, in which:

FIG. 1 is a diagram schematically illustrating the entire configuration of an X-ray transmission inspection apparatus and an extraneous substance detecting method according to a first embodiment of the disclosure;

FIG. 2 is a diagram schematically illustrating the entire configuration of an X-ray transmission inspection apparatus and an extraneous substance detecting method according to a second embodiment of the disclosure;

FIGS. 3A and 3B are diagrams illustrating a relationship between an X-ray irradiation area and a detection area of a TDI sensor in the second embodiment;

FIGS. 4A and 4B are diagrams illustrating a relationship between the X-ray irradiation area and the detection area of the TDI sensor in the second embodiment;

FIG. 5 is a diagram schematically illustrating the entire configuration of an X-ray transmission inspection apparatus and an extraneous substance detecting method according to a third embodiment of the disclosure; and

FIG. 6 is a diagram schematically illustrating the entire configuration of an X-ray transmission inspection apparatus and an extraneous substance detecting method according to an example of the related art.

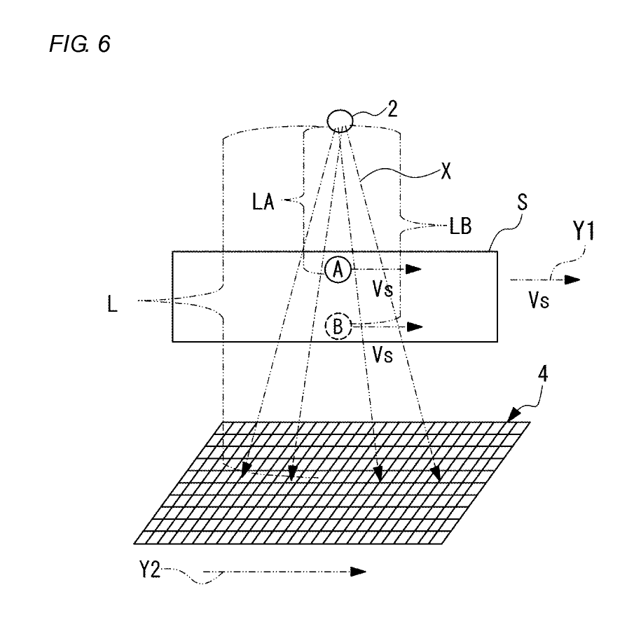

### DETAILED DESCRIPTION

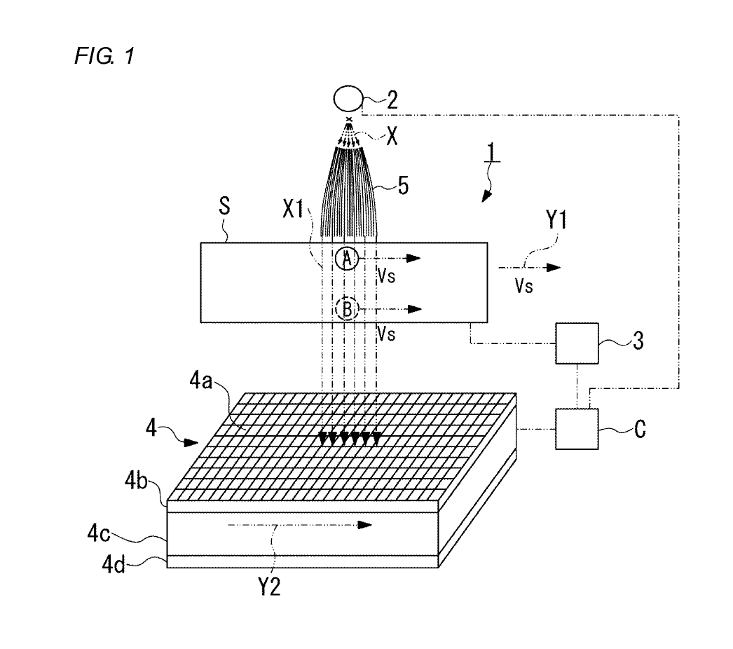

Hereinafter, an X-ray transmission inspection apparatus and an extraneous substance detecting method according to a first embodiment of the disclosure will be described with reference to FIG. 1.

As illustrated in FIG. 1, the X-ray transmission inspection apparatus 1 according to the first embodiment is provided with an X-ray source 2 configured to irradiate a sample S with X-rays, a sample moving mechanism 3 configured to move the sample S, a TDI sensor 4 disposed on a side opposite to the X-ray source 2 with the sample S interposed therebetween and configured to detect the X-rays X transmitted by the sample S, and a polycapillary 5 disposed between the X-ray source 2 and the sample S and configured to convert the X-rays X radially emitted from the X-ray source 2 into parallel X-rays X1 parallel to a thickness direction of the sample S.

The X-ray transmission inspection apparatus 1 is also provided with a control unit C configured to control the TDI sensor 4 so as to detect an extraneous substance corresponding to the received parallel X-rays X1.

The sample S is, for example, a strip-shaped material for a Li-ion battery or a strip-shaped material used in the field of medicine and medical supplies.

The X-ray source 2 is provided with an X-ray tube capable of emitting X-rays and serves to emit X-rays, which are generated by accelerating thermoelectrons generated from a filament (cathode) in the tube by a voltage applied between the filament (cathode) and a target (anode) and causing the thermoelectrons to collide with W (tungsten), Mo (molybdenum), Cr (chromium), or the like as the target, from a window formed of a beryllium foil or the like.

The time delay integration (TDI) sensor 4 is configured with plural cells (sensor elements) in a direction vertical to the moving direction of the sample S and a direction parallel thereto, includes a fluorescent substance 4b disposed on a detection plane 4a, a fiber optics plate (FOP) 4c in which plural fibers are two-dimensionally arranged in the longitudinal and transverse directions below the fluorescent substance 4b, and an Si light-receiving device 4d disposed below the FOP 4c, and has a configuration in which line sensors are arranged in plural columns. For example, in the TDI sensor 4, 200 to 1000 stages of unit line sensors are arranged in a conveyance direction of the sample S.

In the TDI sensor 4, the fluorescent substance 4b such as CsI (cesium iodide), GOS (gadolinium oxysulfide), YAG (yttrium aluminum garnet), or the like is used.

The control unit C is provided with a computer which is connected to the X-ray source 2, the sample moving mechanism 3, the TDI sensor 4, and other components of the X-ray transmission inspection apparatus 1, and which includes a processor (CPU) controlling these components.

The control unit C has functions of synchronizing the charge transfer direction and speed of the TDI sensor 4 with the moving direction and speed of the sample S and integrating luminance values of the X-rays X which the TDI sensor 4 receives in the detection area of the light-receiving plane 4a.

That is, the control unit C sets the charge transfer speed (transfer speed) V_{TDI} and the driving direction in the detection area of the TDI sensor 4 to be equal to the speed V_{S} of the sample S and controls the conveyance of the sample S and the integration process of the TDI sensor 4 in synchronization with each other.

In the drawing, an arrow Y1 denotes the moving direction of the sample S, and an arrow Y2 denotes the TDI driving direction of the TDI sensor 4.

The sample moving mechanism 3 is provided with a motor or the like which moves the sample S in the extending direction of the sample S relative to the TDI sensor 4. The sample moving mechanism 3 may also be provided with, for example, a pair of rollers (not illustrated) which moves the strip-shaped sample S in the extending direction in a roll-to-roll manner.

The polycapillary 5 is formed of, for example, a bundle of hollow glass tubes (capillaries) having an inner diameter of about 10 μm. The polycapillary is a device which causes incident X-rays X to propagate through inner walls of the capillaries in a total reflection manner, condenses the X-rays X by directing the outlets of the capillaries in the same direction, and converts the X-rays X into parallel X-rays X1. That is, in the polycapillary 5, incidence ends of the capillaries are disposed to face the X-ray source 2 on the incidence side of the X-rays X, and all the emission ends of the capillaries are disposed to face the same direction (the direction perpendicular to the surface of the sample S) on the emission side of the X-rays X.

In this manner, in the X-ray transmission inspection apparatus 1 and the extraneous substance detecting method according to the first embodiment, since the X-ray transmission inspection apparatus includes the polycapillary 5 disposed between the X-ray source 2 and the sample S so as to convert the X-rays X radially emitted from the X-ray source 2 into the parallel X-rays X1 which are parallel to the thickness direction of the sample S, the X-rays X with which the sample S is irradiated are converted into the parallel X-rays X1 by the polycapillary 5, and thus the moving speed of the transmission image on the TDI sensor 4 becomes constant regardless of the position of the extraneous substance in the thickness direction. Accordingly, it is possible to form a good X-ray transmission image without causing a blur of an extraneous substance at any position.

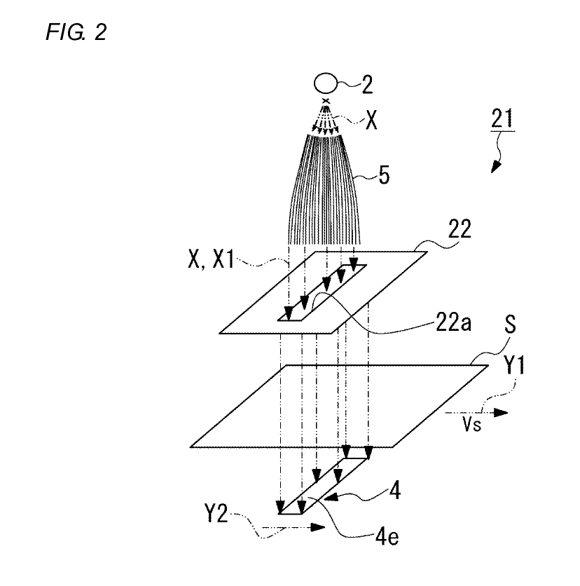

Next, X-ray transmission inspection apparatuses and extraneous substance detecting methods according to second and third embodiments of the invention will be described with reference to FIGS. 2 to 5. In the description of the embodiments, the same elements as those of the above-described embodiment are referenced by the same reference numerals, and description thereof will not be repeated.

The second embodiment is different from the first embodiment in terms of the following point. In the first embodiment, the sample S is irradiated with the parallel X-rays X1 emitted from the polycapillary 5 without any change. However, as illustrated in FIG. 2, an X-ray transmission inspection apparatus 21 according to the second embodiment further includes an aperture member 22 as an X-ray irradiation area limiting member which is disposed between the polycapillary 5 and the sample S so as to pass only the X-rays of a central portion of the parallel X-rays X1 through an opening 22a.

In the aperture member 22, the opening 22a is set depending on a size of an X-ray irradiation area X2 of the parallel X-rays X1 and a size of a detection area 4e of the TDI sensor 4. In this embodiment, the opening 22a is formed to have a rectangular shape which is elongated in a direction perpendicular to the moving direction of the sample S. Therefore, the detection area 4e of the TDI sensor 4 is a rectangular area which corresponds to the shape of the opening 22a and is moved depending on the charge transfer direction (driving direction) and speed corresponding to the moving direction and speed of the sample S.

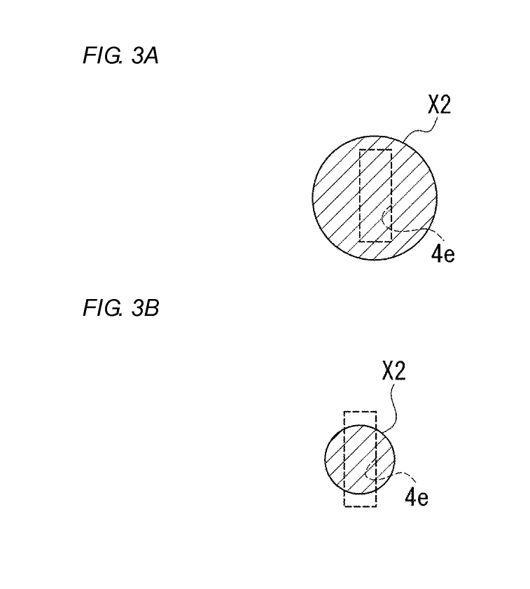

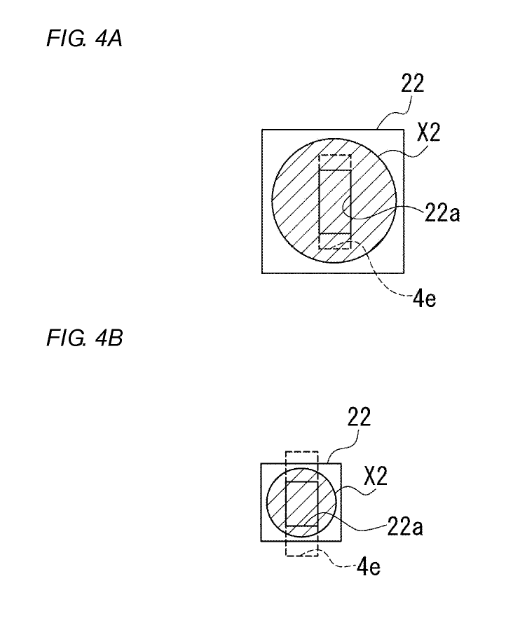

For example, when the detection area 4e of the TDI sensor 4 is smaller than the X-ray irradiation area X2 of the parallel X-rays X1 as illustrated in FIG. 3A and the X-ray irradiation area X2 is larger than the opening 22a of the aperture member 22 as illustrated in FIG. 4A, the opening 22a of the aperture member 22 is set to be equal to or slightly smaller than the detection area 4e. By setting the areas in this way, the irradiation of unnecessary positions with the parallel X-rays X1 can be prevented, the error factors in measurement due to the influence of scattered rays or the like can be excluded, and it is thus possible to enable more accurate measurement.

When the detection area 4e of the TDI sensor 4 is set to be larger than the X-ray irradiation area X2 of the parallel X-rays X1 as illustrated in FIG. 3B and the opening 22a of the aperture member 22 is smaller than the X-ray irradiation area X2 and is included in the detection area 4e as illustrated in FIG. 4B, the cells of the TDI sensor 4 in which irregular irradiation with the X-rays occurs due to a halo of high-energy X-rays included in the peripheral edge portion of the X-ray irradiation area X2 is covered with the shielding portion of the aperture member 22. By performing this setting, it is possible to eliminate the sensitivity irregularity in the passage of the extraneous substance in the detection area 4e of the TDI sensor 4.

In this manner, in the X-ray transmission inspection apparatus 21 and the extraneous substance detecting method using the X-ray transmission inspection apparatus according to the second embodiment, since the X-ray transmission inspection apparatus includes the aperture member 22 disposed between the polycapillary 5 and the sample S so as to transmit only the X-rays of the central portion among the parallel X-rays through the opening 22a, the X-rays of the peripheral edge portion having intensity greatly decreased in an energy distribution of the X-rays emitted from the central portion and the peripheral edge portion among the parallel X-rays X1 can be blocked by the aperture member 22, thereby suppressing sensitivity irregularity. The sensitivity irregularity may also be called as sensitivity unevenness.

In addition, in the irradiation of the TDI sensor 4 with X-rays, when an irradiation shape is circular and the outer peripheral portion thereof is present inside the sensor, cells which are irradiated with the X-rays and cells which are not irradiated with the X-rays are present in a column of the sensor in the conveyance direction, and an error may be caused in the integration of detected intensity. Accordingly, it is possible to prevent the error.

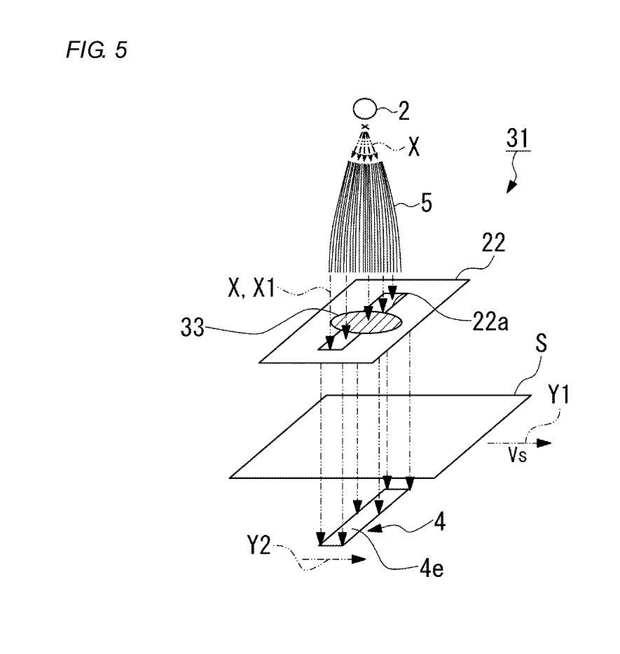

The third embodiment is different from the second embodiment in terms of the following point. In the second embodiment, only the aperture member 22 is disposed between the polycapillary 5 and the sample S. However, as illustrated in FIG. 5, the X-ray transmission inspection apparatus 31 according to the third embodiment further includes a filter 33 which is disposed between the polycapillary 5 and the sample S so as to reduce the intensity of the X-rays of the central portion of the parallel X-rays X1.

The filter 33 is installed on the aperture member 22 and is disposed at a position corresponding to the central portion in an irradiation cross-section of the parallel X-rays X1. The filter 33 may employ, for example, a film of a material (W (tungsten), Mo (molybdenum), Cr (chromium), or the like) used as a target of an X-ray tube or a material having an atomic number close to the atomic number of the aforementioned material.

As described above, the X-ray transmission inspection apparatus 31 according to the third embodiment includes the filter 33 disposed between the polycapillary 5 and the sample S so as to reduce the intensity of the X-rays of the central portion among the parallel X-rays X1. Accordingly, when the X-ray energy intensity of the central portion of the parallel X-rays X1 is larger than that of the peripheral portion, it is possible to make sensitivities in the central portion and the peripheral portion uniform by reducing the X-ray intensity of the central portion.

The technical scope of the invention is not limited to the above-described embodiments, and various changes can be made without departing from the spirit of the invention.

For example, in the above-described embodiments, the polycapillary configured to convert the X-rays emitted from the X-ray source as a circular light source into the parallel X-rays having a circular cross-section is used. However, when the X-ray source is a rectangular light source, a polycapillary configured to convert the X-rays emitted from the X-ray source in to parallel X-rays having a rectangular cross-section may be used.

The number of poly-capillaries in the driving direction of the TDI sensor may be set to be the same, thereby making the parallel X-rays, with which the sample on the detection area of the TDI sensor is irradiated, uniform.

In the above-described embodiments, the aperture is used as the X-ray irradiation area limiting member. However, for example, a slit other than the aperture may be used as long as it can achieve the same purpose and does not cause a problem in inspection.

As described with reference to the embodiments, according to a first aspect of the present disclosure, there is provided an X-ray transmission inspection apparatus provided with: an X-ray source configured to irradiate a sample with an X-ray; a sample moving mechanism configured to continuously move the sample in a specific direction during irradiation with the X-ray from the X-ray source; a TDI sensor disposed at a side opposite to the X-ray source with the sample interposed therebetween and configured to detect the X-ray transmitted by the sample; and a polycapillary disposed between the X-ray source and the sample and configured to convert the X-ray radially emitted from the X-ray source into a parallel X-ray parallel to a thickness direction of the sample.

Since the X-ray transmission inspection apparatus according to the first aspect is provided with the polycapillary disposed between the X-ray source and the sample so as to convert the X-rays radially emitted from the X-ray source into the parallel X-rays which are parallel to the thickness direction of the sample, the X-rays with which the sample is irradiated are converted into the parallel X-rays by the polycapillary, and thus the moving speed of the transmission image on the TDI sensor becomes constant regardless of the position of the extraneous substance in the thickness direction. Accordingly, it is possible to form a good X-ray transmission image without causing a blur of an extraneous substance at any position.

A second aspect of the present disclosure provides the X-ray transmission inspection apparatus according to the first aspect, further being provided with an X-ray irradiation area limiting member disposed between the polycapillary and the sample and configured to pass only the X-ray of a central portion of the parallel X-ray through an opening.

Firstly, since the X-ray transmission inspection apparatus according to the second aspect is provided with the X-ray irradiation area limiting member disposed between the polycapillary and the sample so as to transmit only the X-rays of the central portion among the parallel X-rays through the opening, the X-rays of the peripheral edge portion having intensity greatly decreased in an energy distribution of the X-rays emitted from the central portion and the peripheral edge portion among the parallel X-rays can be blocked by the X-ray irradiation area limiting member such as an aperture, thereby suppressing sensitivity irregularity.

Secondly, in the irradiation of the TDI sensor with X-rays, when an irradiation shape is circular and the outer peripheral portion thereof is present inside the sensor, cells (sensor elements) which are irradiated with the X-rays and cells which are not irradiated with the X-rays are present in a column of the sensor in the conveyance direction, that is, irradiation irregularity occurs. As a result, an error may be caused in the integration of detected intensity. Accordingly, it is possible to prevent the error.

A third aspect of the present disclosure provides the X-ray transmission inspection apparatus according to the first or second aspect, further including a filter disposed between the polycapillary and the sample and configured to reduce intensity of the X-ray of a central portion of the parallel X-ray.

The X-ray transmission inspection apparatus according to the third embodiment is provided with filter disposed between the polycapillary and the sample so as to reduce the intensity of the X-rays of the central portion among the parallel X-rays. Accordingly, when the X-ray energy intensity of the central portion of the parallel X-rays is larger than that of the peripheral portion, it is possible to make sensitivities in the central portion and the peripheral portion uniform by reducing the X-ray intensity of the central portion.

According to a fourth aspect of the present disclosure, there is provided an extraneous substance detecting method using an X-ray transmission inspection apparatus, the X-ray transmission inspection apparatus including an X-ray source configured to irradiate a sample with an X-ray, a sample moving mechanism configured to continuously move the sample in a specific direction during irradiation with the X-ray from the X-ray source, a TDI sensor disposed on a side opposite to the X-ray source with the sample interposed therebetween and configured to detect the X-ray transmitted by the sample, and a polycapillary disposed between the X-ray source and the sample, the extraneous substance detecting method including: causing the polycapillary to convert the X-ray radially emitted from the X-ray source into a parallel X-ray parallel to a thickness direction of the sample; and causing the sample moving mechanism to continuously move the sample in a specific direction during irradiation with the parallel X-ray.

In the extraneous substance detecting method according to the fourth aspect, the X-ray transmission inspection apparatus according to the invention is used, the X-rays radially emitted from the X-ray source are converted into the parallel X-rays parallel to the thickness direction of the sample by the polycapillary, and the sample is continuously moved in a specific direction during irradiation with the parallel X-rays by the sample moving mechanism. Accordingly, the moving speed of the transmission image on the TDI sensor becomes constant regardless of the position of the extraneous substance in the thickness direction, and it is thus possible to form a good X-ray transmission image without causing a blur of an extraneous substance at any position.

A fifth aspect of the present disclosure provides the extraneous substance detecting method according to the fourth aspect, wherein the X-ray transmission inspection apparatus further includes an X-ray irradiation area limiting member disposed between the polycapillary and the sample and configured to pass only the X-ray of a central portion of the parallel X-ray through an opening, and the extraneous substance detecting method further comprises causing the X-ray irradiation area limiting member to limit an irradiation area with the parallel X-ray.

In the extraneous substance detecting method according to the fifth aspect, since the irradiation area of the parallel X-ray is limited by the X-ray irradiation area limiting member, it is possible to block the X-rays of the peripheral edge portion having intensity greatly decreased in the energy distribution of the X-rays emitted from the central portion and the peripheral edge portion among the parallel X-rays. In addition, it is possible to reduce irradiation irregularity between cells (sensor elements) of the TDI sensor which are arranged to be parallel to the conveyance direction of the sample in the outer peripheral portion of the parallel X-rays with the TDI sensor is irradiated, is decreased.

According to the present disclosure, the following advantages can be obtained.

In the X-ray transmission inspection apparatuses and the extraneous substance detecting methods according to the above described aspects, since the X-ray transmission inspection apparatus is provided with the polycapillary disposed between the X-ray source and the sample so as to convert the X-rays radially emitted from the X-ray source into the parallel X-rays which are parallel to the thickness direction of the sample, it is possible to form a good X-ray transmission image without causing a blur of an extraneous substance at any position regardless of the position of the extraneous substance in the thickness direction. Accordingly, it is possible to improve sensitivity by detecting an extraneous substance without causing a blur in the transmission image due to speed asynchronization even in the case of a thick sample.

What is claimed is:

1. An X-ray transmission inspection apparatus comprising:
an X-ray source configured to irradiate a sample with an X-ray;
a sample moving mechanism configured to continuously move the sample in a specific direction during irradiation with the X-ray from the X-ray source;
a TDI sensor disposed at a side opposite to the X-ray source with the sample interposed therebetween and configured to detect the X-ray transmitted by the sample; and
a polycapillary disposed between the X-ray source and the sample and configured to convert the X-ray radially emitted from the X-ray source into a parallel X-ray parallel to a thickness direction of the sample.

2. The X-ray transmission inspection apparatus according to claim 1 further comprising:
an X-ray irradiation area limiting member disposed between the polycapillary and the sample and configured to pass only the X-ray of a central portion of the parallel X-ray through an opening.

3. The X-ray transmission inspection apparatus according to claim 1 further comprising:
a filter disposed between the polycapillary and the sample and configured to reduce intensity of the X-ray of a central portion of the parallel X-ray.

4. An extraneous substance detecting method using an X-ray transmission inspection apparatus including an X-ray source configured to irradiate a sample with an X-ray, a sample moving mechanism configured to continuously move the sample in a specific direction during irradiation with the X-ray from the X-ray source, a TDI sensor disposed on a side opposite to the X-ray source with the sample interposed therebetween and configured to detect the X-ray transmitted by the sample, and a polycapillary disposed between the X-ray source and the sample, the method comprising:
causing the polycapillary to convert the X-ray radially emitted from the X-ray source into a parallel X-ray parallel to a thickness direction of the sample; and
causing the sample moving mechanism to continuously move the sample in a specific direction during irradiation with the parallel X-ray.

5. The extraneous substance detecting method according to claim 4,
wherein the X-ray transmission inspection apparatus further includes an X-ray irradiation area limiting member disposed between the polycapillary and the sample and configured to pass only the X-ray of a central portion of the parallel X-ray through an opening, and
wherein the method further comprises:
causing the X-ray irradiation area limiting member to limit an irradiation area with the parallel X-ray.
